(19) United States
(12) Patent Application Publication
(10) Pub. No.: US 2006/0271902 A1
(43) Pub. Date: Nov. 30, 2006

(54) Semiconductor integrated circuit designing method and library designing method

(75) Inventors: Kyoji Yamashita, Kyoto (JP); Katsuhiro Ootani, Nara (JP); Katsuya Arai, Kyoto (JP); Daisaku Ikoma, Osaka (JP); Hiroki Taniguchi, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/334,506

(22) Filed: Jan. 19, 2006

(30) Foreign Application Priority Data
May 26, 2005 (JP) 2005-154110

(51) Int. Cl. G06F 17/50

(52) U.S. Cl. 716/17; 716/18

(57) ABSTRACT

A method for designing a semiconductor integrated circuit includes: a step (a) of setting basic patterns including a plurality of active region/gate patterns each including a gate and an active region and a dummy gate while taking account of patterns of gates on the respective sides of each gate; a step (b) of forming a plurality of basic pattern combinations by combining some of the basic patterns; and a step (c) of forming a standard cell by combining some of the plurality of basic pattern combinations. The plurality of basic pattern combinations include a single transistor (large width), a single transistor (small width), and parallel connected N transistors (large width), for example.

### CROSS REFERENCE TO RELATED APPLICATIONS

This Non-provisional application claims priority under 35 U.S.C. § 119(a) on Patent Application No. 2005-154110 filed in Japan on May 26, 2005, the entire contents of which are hereby incorporated by reference.

### BACKGROUND ART

1. Field of the Invention

The present invention relates to a method for designing a semiconductor integrated circuit including a miniaturized transistor, and more particularly relates to a measure against the optical proximity effect.

2. Description of the Prior Art

Significant factors in variation in propagation delay time in designing a semiconductor integrated circuit (LSI) include variation in voltage of an operation source, temperature, variations on process, and the like. LSIs must be designed so that the operation thereof is ensured even under the worst conditions of all the above factors in variation in propagation delay time. Of aspects of a transistor, the gate length is one of the most significant aspects for defining operation of the transistor, and variation in gate length occupies large in the variations on process. In association with recent miniaturization of the transistors, the gate length is shortened more and more, inviting increase in variation in gate length. For this reason, the variation in propagation delay time increases to invite the need to increase design margins. This yields difficulty in provision of high performance LSIs.

In a general semiconductor manufacturing process, an integrated circuit is formed on a semiconductor substrate by repetition of a photolithography step including resist application, exposure, and development, an etching step for pattering elements with the use of a resist mask, and a resist removing step. For forming a gate of a transistor, the photolithography step, the etching step, and the resist removing step are carried out, also. When the pattern dimension is less than the wavelength of the exposure light at the exposure in the photolithography step, an error between the layout dimension at design and the actual dimension of the pattern on the semiconductor substrate becomes large due to the optical proximity effect by influence of diffracted light.

For solving the above problems, there is a technique of OPC (Optical Proximity Correction) for correcting the influence of the optical proximity effect by modifying a circuit pattern drawn on the mask.

Further, another method is effective in which the finished size is feedbacked to a net list that contains connection information of circuit elements with the OPC performed. A typical method is disclosed in Japanese Patent Application Laid Open Publication No. 2004-30382A.

FIG. 8 shows the typical method of designing a semiconductor device disclosed in Japanese Patent Application Laid Open Publication No. 2004-30382A. This method is aimed at obtaining an error of element values which is caused due to rounding of a part having a relax angle (an angle exceeding 180°) by exposure in manufacturing a semiconductor device. Error detecting means 151 detects an element pattern including a part having a relax angle from physical data indicating element patterns to be formed on a semiconductor substrate. Error computing means 152 computes an error caused due to rounding of the part having the relax angle at exposure. Element value computing means 153 computes variation in element value of the corresponding element on the basis of the error computed by the error computing means 153.

### SUMMARY OF THE INVENTION

As described above, the gate length is shortened in association with progress in miniaturization of the transistors, so that the influence of the optical proximity effect by diffracted light at exposure of the gates becomes severe. Though OPC significantly improves pattern dependency of the finished size of the gate length Lg, which varies due to the influence of the optical proximity effect, absolute correction of the dependency is impossible. Therefore, accurate correction to every pattern used for standard cells is difficult in the conventional OPC technique.

Even in the conventional design method in which the finished size is feedbacked to a net list that contains connection information of circuit elements, accurate prediction of every pattern used for standard cells is rather difficult.

FIG. 9 is a graph showing finished size distribution of the gate length of the standard cells in the 0.13 μm process generation with respect to frequency of use in an LSI, and FIG. 10 is a graph showing distribution of delay library error (difference between a simulation value and an actual measurement value) in the standard cells in the 0.13 μm process generation with respect to frequency of use in an LSI. Wherein, the design dimension of the gate length is 100 nm.

The examples shown in FIG. 9 and FIG. 10 prove that the cell layout dependency of the gate length is remarkably large and the accuracy of the delay library (delay information of a standard cell) is notably low according to cells.

FIG. 11A and FIG. 11B show conventional libraries in the 0.13 μm process generation. As shown in the drawings, the conventional libraries are designed by combining various patterns different in active region (OD) 101, shape of a gate 102, and the like. For this reason, finished size evaluation for all cells through SEM photograph is much difficult.

The present invention has its objective of providing a semiconductor integrated circuit designing method capable of suppressing variation in gate length which is due to the optical proximity effect and a library designing method that ensures cell characteristics.

A semiconductor integrated circuit designing method of the present invention is a method for designing a semiconductor integrated circuit with the use of a standard cell having a plurality of gates and active regions, including: a step (a) of setting basic patterns including a plurality of active region/gate patterns each including a gate and an active region and at least one dummy gate, while taking account of patterns of adjacent gates on respective sides of each gate of the plurality of gates; a step (b) of forming a plurality of basic pattern combinations in which patterns of gates on the respective sides of each gate of the plurality of gates are different from each other by combining some of the basic patterns set in the step (a); a step (c) of forming the standard cell by combining some of the plurality of basic pattern combinations; and a step (d) of designing the semiconductor integrated circuit with the use of the standard cell.

By this method, the number of basic pattern combinations used for the standard cell can be reduced, so that the characteristics of the standard cell can be ensured through preliminary evaluation of electric characteristics of the layout by TEG (Test Element Group). Further, the number of the basic patterns is limited, resulting in easy optimization of OPC.

The plurality of active region/gate patterns may include at least: a first active region/gate pattern including a gate in a straight shape having a protruding pad portion serving as a contact region; and a second active region/gate pattern including N gates in a same straight shape in parallel with each other and a bridging gate for connecting the N gates in parallel with each other, where N is a natural number larger than 1.

The plurality of active region/gate patterns may further include a third active region/gate pattern including a gate which is in the same shape as the gate of the first active region/gate pattern and which has an active region different in width from that of the first active region/gate pattern.

The design method of the present invention is preferably applied to a logic circuit or a logic circuit section provided on an output side of a sequential circuit. Application to them increases design accuracy without inviting area increase.

A library designing method of the present invention is a method for designing a library for a semiconductor integrated circuit designed with the used of a cell including a plurality of transistors having gates, including: a step (a) of extracting a parameter in each of the plurality of transistors pattern by pattern of gates on respective sides of each of the gates; and a step (b) of forming a library which reflects a real characteristic with the use of the parameter extracted in the step (a).

According to this method, the number of the patterns from which parameters are extracted in the step (a) can be reduced compared with the conventional one to enable highly accurate evaluation in a short period of time. As a result, a library with high accuracy can be designed.

### BRIEF DESCRIPTION OF THE DRAWINGS

FIG. 1 is a diagram showing a pattern used for studying influence of two or more gates apart from a transistor having a subject gate to be evaluated and influence in the longitudinal direction by carrying out optical simulation.

FIG. 2 is a table showing parameter allocation for studying influence of a third adjacent gate 14 and a fourth adjacent gate 15 which are arranged two gates apart from a subject gate 11 on a transistor to be evaluated having a gate 2 and an active region 1.

FIG. 3 is a diagram showing examples the shapes in plan of basic patterns of which layout is limited and a dummy gate to be arranged on the boundary between cells which are used in the design method according to Embodiment 1 of the present invention.

FIG. 4 shows examples for forming a standard cell composed of the basic patterns shown in FIG. 3.

FIG. 5 is a flowchart showing a procedure for highly accurately designing a semiconductor integrated circuit under cell layout limitation.

FIG. 6 is a circuit diagram showing an example of a sequential circuit cell to which a design method according to Embodiment 2 of the present invention is applied.

FIG. 7A to FIG. 7D are diagram showing examples for library design according to combinations of adjacent cells in the semiconductor integrated circuit designing method according to Embodiment 2 of the present invention.

FIG. 8 is a block diagram showing an example of a conventional semiconductor device designing method.

FIG. 9 is a graph showing finished size distribution of gate length of standard cells in the 0.13 μm process generation with respect to frequency of use in an LSI.

FIG. 10 is a graph showing distribution of delay library error (difference between a simulation value and an actual measurement value) in standard cells in the 0.13 μm process generation with respect to frequency of use in an LSI.

FIG. 11A and FIG. 11B shows examples of conventional libraries in the 0.13 μm process generation.

### DESCRIPTION OF THE PREFERRED EMBODIMENTS

-Study of Influence of Peripheral Layout-

In developing a method for designing a semiconductor integrated circuit, the present inventors have studied influence of peripheral layout around a subject gate on finished size of the subject gate. Because, simplification of a standard cell might be possible if a range of peripheral layout that influences finished size of a subject gate would be known.

First, the present inventors examined the range of peripheral layout to be taken into consideration for a subject gate to be evaluated through optical simulation.

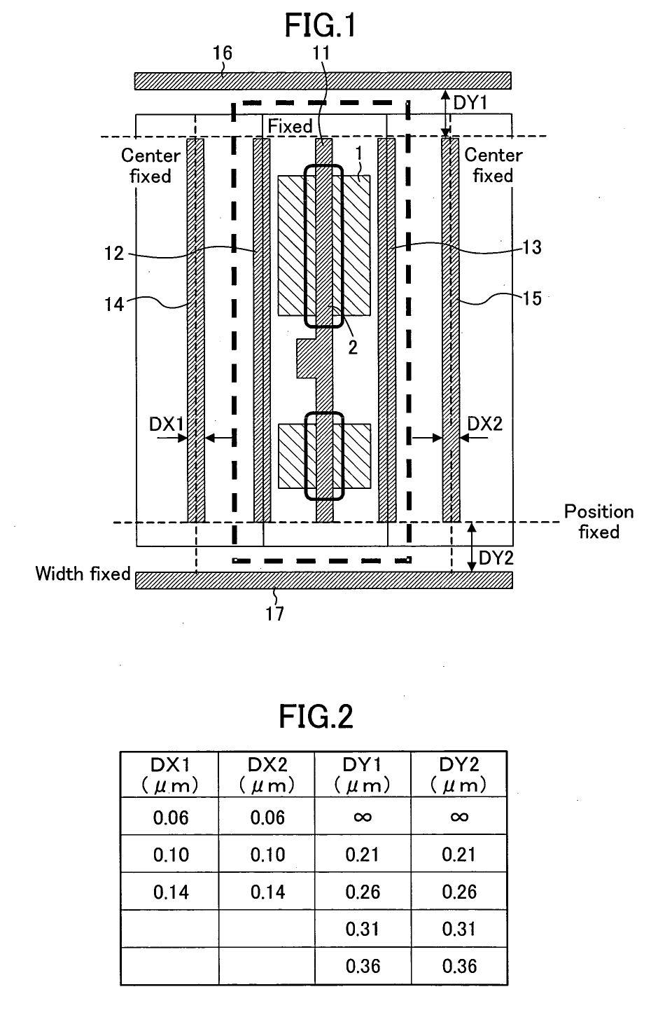

FIG. 1 shows a pattern used for studying influence of two or more gates apart from a transistor having a subject gate to be evaluated and influence in the longitudinal direction through optical simulation. A pattern is used in this measurement which includes: a subject gate 11 to be evaluated formed on a substrate; a first adjacent gate 12 and a second adjacent gate 13 which are arrange in parallel with the subject gate 11 so as to interpose the subject gate 11, a third adjacent gate 14 arranged in parallel with the subject gate 11 with the first adjacent gate 12 interposed (in other words, arranged two gates apart from the subject gate 11); a fourth adjacent gate 15 arranged in parallel with the subject gate 11 with the second adjacent gate 13 interposed (in other words, arranged two gates apart from the evaluation gate 11); an active region (OD) 1 formed at a part of a substrate region located on both sides of the subject gate 11; a fifth adjacent gate 16 arranged with a distance DY1 left from the subject gate 11 and extending in the direction intersecting at a right angle with the subject gate 11; and a sixth adjacent gate 17 arranged with a distance DY2 left from the subject gate 11 and extending in the direction intersecting at a right angle with the subject gate 11. In FIG. 1, reference DX1 denotes a gate length of the third adjacent gate 14, and DX2 denotes a gate length of the fourth adjacent gate 15. A region of the evaluation gate 11 where it is interposed by the active region 1 in plan is a gate (GA) 2.

In the study, the shape and the position of the part enclosed by the dotted line in FIG. 1, that is, a region of the subject gate 11, the first adjacent gate 12, the second adjacent gate 13, and the active region 1 is fixed. Also, each central position in the longitudinal direction of the third adjacent gate 14 and the fourth adjacent gate 15 and each width (length in short-side direction) of the fifth adjacent gate 16 and the sixth adjacent gate 17 are fixed.

FIG. 2 is a table showing parameter allocation for studying influence on a transistor to be evaluated having the gate 2 and the active region 1 by the third adjacent gate 14 and the fourth adjacent gate 15 which are arranged two gates apart in the direction of the gate length from the subject gate 11 and the fifth adjacent gate 16 and the sixth adjacent gate 17 which are arranged on the respective sides in the direction of the gate width of the subject gate 11.

As understood from FIG. 2, when DX1, DX2, DY1, and DY2 are changed, the variation range of the gate length after the gate 2 is finished slightly exceeds 1 nm on 3σ conversion. This result proves that there is less or no influence of the shapes and the positions of the gates arranged two gates apart in the direction of the gate length from the subject gate and the gates on the respective sides in the direction of the gate width of the subject gate 11, and only influence of the adjacent gates arranged on the respective sides of the subject gate must be considered in designing a semiconductor integrated circuit. A method for designing a semiconductor integrated circuit, which the present inventors have achieved on the basis of this finding, will be described below in detail.

### Embodiment 1

In a method for designing a semiconductor integrated circuit according to the present embodiment, a standard cell is formed of a combination of limited combinations of patterns of a active region and a gate (hereinafter abbreviated as “OD/GA patterns”), each limited combination including gates on the respective sides of a subject gate. This enables preliminary evaluation of electric characteristics in layouts of the limited combinations by TEG (Test Element Group), ensuring the characteristics of the standard cell. Further, the OD/GA patterns are limited to finite simple patterns, facilitating optimization of OPC.

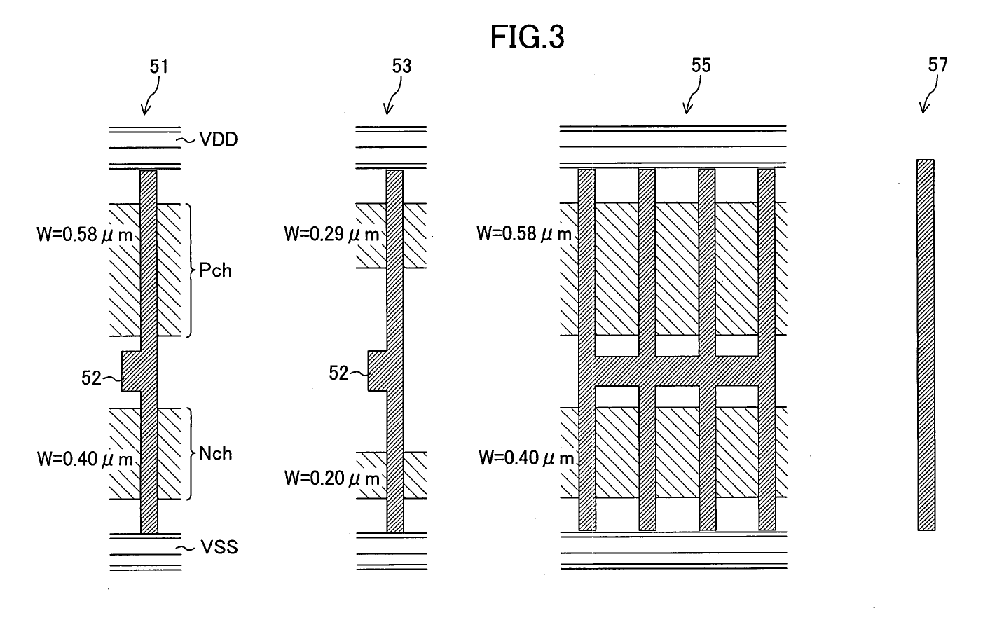

FIG. 3 shows shapes in plan of the OD/GA patterns of which layout is limited in the design method of the present embodiment and a pattern of a dummy gate to be arranged at the boundary of cells. The patterns shown in FIG. 3 are called “basic patterns” in the present description.

FIG. 3 shows a single transistor (large width) 51 having a large active region, a single transistor (small width) 53 having a small active region of which width is approximately ½ of that of the single transistor (large width) 51, N transistors (large width) 55 having a large active region and arranged in parallel with each other, wherein N is a natural number larger than 1, and a dummy gate 57. Wherein, in evaluation of a transistor, 4 can be represented as N in the N transistors (large width) 55 connected in parallel with each other, as will be described later. Each of the single transistor (large width) 51 and the single transistor (small width) 53 includes a gate (GA) in a straight shape having a protruding pad portion 52 serving as a contact region, and each pattern thereof includes a P-channel transistor and an N-channel transistor with the pad portion 52 interposed. The gate 2 is arranged between a source wire Vdd and a grounding wire Vss. The N transistors (large width) 55 arranged in parallel with each other forms a pattern in which gates 2 in the same straight shape arranged in parallel with each other are connected by means of a bridging gate. The single transistor (large width) 51 has cell driving capacity larger than the single transistor (small width) 53, and the cell driving capacity of the N transistors connected in parallel with each other depends on the number N of the transistors. There are patterns in reverse of the above patterns with respect to the X axes (the center lines of the patterns). Referring to the dummy gate 57 shown in FIG. 3, only one dummy gate having a single shape is prepared when the pitch of the gates 2 agrees with the wiring pitch while another dummy gate having another thickness (gate length) is also prepared for the case where the pitch of the gate 2 do not agree with the wiring pitch, as will be described later. In the example shown in FIG. 3, the gate length of the dummy gate 57 is equal to the gate length of the gate 2 of the single transistors 51, 53. Combination of the basic patterns shown in FIG. 3 forms patterns (hereinafter referred to as “basic pattern combinations”) used for a standard cell. It is noted that though only two types of gate widths W are shown in the patterns for the single transistors, design for a logic circuit or the like can be carried out with accuracy even in this case.

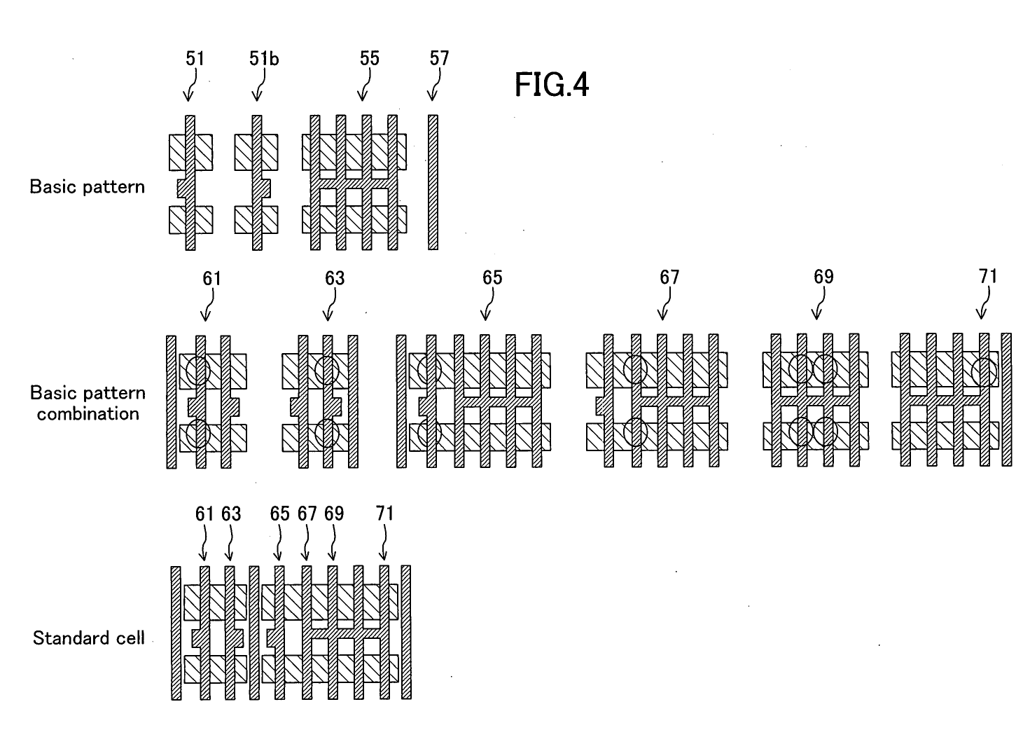

FIG. 4 shows examples for forming a standard cell with the use of the basic patterns shown in FIG. 3. As shown in FIG. 4, basic pattern combinations 61, 63, 65, 67, 69, 71 can be formed by combining some of the basic patterns shown in FIG. 3. The transistors to be evaluated are marked by circles. A single transistor (large width) 51b in FIG. 4 is a transistor in reverse of the single transistor (large width) 51 with respect to the center line of the gate as an axis.

Further, FIG. 4 shows some of the basic patterns in which the single transistor (small width) 53 shown in FIG. 3 is also included. Accordingly, there are 23 basic pattern combinations in total according to which patterns of the four basic patterns shown in FIG. 3 are arranged adjacent to the respective sides of each of the three kinds of transistors, that is, the single transistor (large width) 51, the single transistor (small width) 53, and the parallel connected N transistors (large width) 55. In the basic pattern combinations, the positions of the pad portions 52 are taken into consideration. For example, there are two combinations counted according to the cases where the pad portions 52 of the adjacent gates face each other or not. While, pattern combinations symmetrical with respect to the center line of the cell as an axis are counted as one combination.

A standard cell is formed by combining basic pattern combinations arbitrarily selected from the 23 basic pattern combinations including the pattern combinations 61, 63, 65, 67, 69, 71, as shown in FIG. 4. Steps for forming the standard cell and steps for designing a semiconductor integrated circuit with the use of the formed standard cell may be carried out manually or with the use of a computer in which a design tool is incorporated. In this way, all logic cells can be formed by using basic pattern combinations in combination of basic patterns of a subject gate and the gates adjacent to the subject gate which are formed with the use of only the basic patterns of the three types of OD/GA patterns and a dummy gate arranged on the cell boundary.

Herein, the reason why an OD/GA pattern of parallel connected N transistors (large width) where N is 4 can represent all patterns of parallel connected N transistors where N is 2 or larger in evaluating parallel connected N transistors (large width) will be described. In the parallel connected N transistors (large width) 55 as shown in FIG. 4, only a pattern including the gate at the left end in the parallel connected N transistors (large width) 55 is influenced by a gate arranged on the left side thereof. On the other hand, the right end pattern that is influenced by a gate arranged on the right side of the parallel connected N transistors (large width) 55 is a pattern in reverse of the pattern including the gate at the left end thereof. Further, for evaluating a transistor except transistors having gates arranged on the respective ends thereof, influence of gates two or more gates apart from a subject transistor is not taken into consideration while influence of the adjacent gates of the subject transistor is taken into consideration. Thus, the transistors except the transistors arranged on the respective ends can be all regarded as transistors having the same pattern even in the case where N is 2 or larger. Hence, the pattern where N is 4 can be represented in any cases where N is 2 or larger. The reason why 4 is selected as N is that the pattern of four transistors connected in parallel with each other has an average size in semiconductor integrated circuits.

In the standard cell formed as above, the number of combinations of the basic patterns is reduced remarkably by taking only the adjacent gates into consideration, compared with the conventional one, so that evaluation of the shape and the electric characteristics of a transistor to be evaluated having a subject gate can be carried out easily and accurately. In this connection, variation in gate length of MIS transistors, which is due to the optical proximity effect caused in the photolithography step, can be suppressed, attaining accurate circuit design.

It is noted that the effects in view of only the gate length is described in the present embodiment but the design method of the present embodiment is effective in effects in view of other layout aspects such as the shape of an active region, distance between the end of an active region and a gate, and the like.

### Embodiment 2

A semiconductor integrated circuit designing method and a library designing method according to Embodiment 2 of the present invention will be described below with reference to the accompanying drawings.

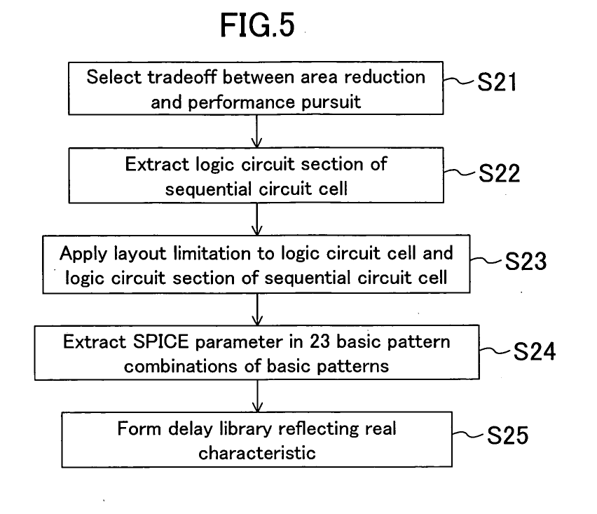

FIG. 5 is a flowchart showing a procedure for designing a semiconductor integrated circuit with high accuracy with cell layout limited. Wherein, each step described below is carried out by a computer in which a design tool is incorporated.

As shown in FIG. 5, in the semiconductor integrated circuit designing method of the present embodiment, trade-off between area reduction and performance pursuit in a semiconductor integrated circuit to be designed is selected in a step S21. In this step, a part where more importance is placed on that a gate and a transistor are to be formed as designed, namely, on performance is distinguished from a part where more importance is placed on that the area is to be reduced in the semiconductor integrated circuit and the part where more importance is placed on that they are to be formed as designed is extracted. Herein, the semiconductor integrated circuit includes a sequential circuit cell having a sequential circuit section and a logic circuit section and a logic circuit cell. The logic circuit cell, for example, is extracted in this step.

Next, in a step S22, the logic circuit section of the sequential circuit cell is extracted.

Subsequently, in a step S23, the layout limitation described in Embodiment 1 is applied to the logic circuit cell and the logic circuit section of the sequential circuit cell.

Then, in a step S24, a SPICE parameter in the 23 basic pattern combinations in combination of the basic patterns is extracted with the use of a SPICE parameter extraction tool. Specifically, the SPICE parameter is extracted from a pattern combination in which any of the gate length L, the gate width W, and the design dimension varies out of the 23 basic pattern combinations. The SPICE parameter is extracted in relation to a DC characteristic or a capacity characteristic.

Next, in a step S25, a delay library reflecting actual characteristics of the transistors and the like is formed. The delay library is used for gate level simulation or the like and stores delays of gates each of which fall in a table function between input waveform inclination and output capacity of the gate. The delay library is formed by carrying out SPICE simulation for each gate with the use of the input waveform inclination and the output capacity of a subject gate as parameters. In this step, the SPICE parameter extracted in the step S24 is verified by evaluating delays of all cells with the use of a ring oscillator while referencing the extracted SPICE parameter. The thus formed delay library is stored in storage means such as a memory so as to be in a usable state.

In the design method according to the present embodiment, the parameters are extracted in the basic pattern combinations in the step S24. This enables formation of a delay library with accuracy higher than that of the conventional one in the step S25. Hence, circuit performance evaluation can be carried out in a shorter period of time with higher accuracy than those in the conventional one.

It is noted that the layout limitation is applicable to any circuits but is preferably applied to the logic circuit cell and the logic circuit section of the sequential circuit cell, as shown in the example of FIG. 5. Because, the logic circuit is simpler in layout than the sequential circuit and design to which the layout limitation described in Embodiment 1 is applied causes less increase in area. Actual result where area estimation was carried out using logic circuits having approximately 80 conventional cells or the approximately 80 cells used in the present embodiment shows that less or no increase in area is observed in the logic circuit designed by the method according to the present embodiment compared with the conventional logic circuit. The logic circuits to which the method of the present embodiment is applicable include a logic circuit used for a clock line, for example.

Referring to the sequential circuit cell, only one cell is used in view of a delay path in an LSI in contrast to the logic cells in about 25 stages. Hence, no application of the layout limitation according to the present embodiment to the sequential circuit cell might invite ignorable influence on delay.

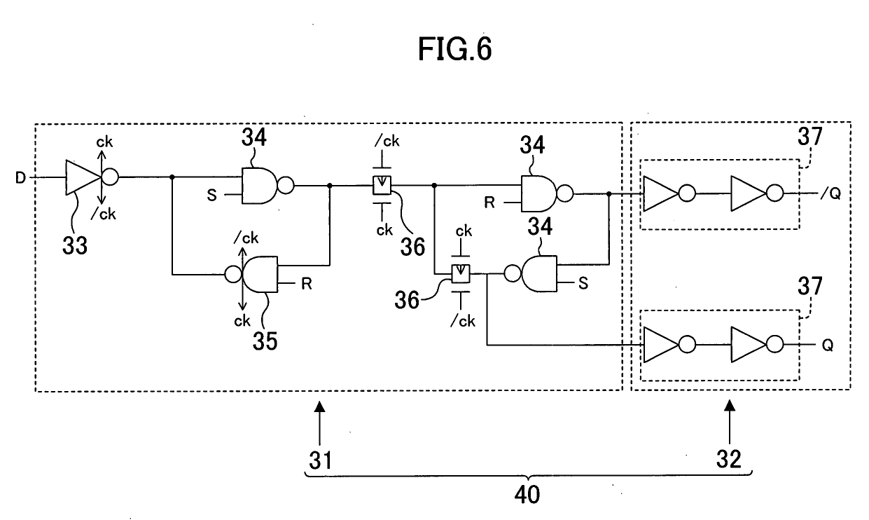

FIG. 6 shows an example of the sequential circuit cell to which the design method of the present embodiment is applied. The sequential circuit cell 40 shown in FIG. 6 includes a sequential circuit section 31 and a logic circuit section 32 for receiving a signal from the sequential circuit section 31 and outputting it to the outside. The sequential circuit section 31 includes, for example, a clocked inverter 33, a clocked NAND 35, a plurality of NANDs 34, and a transfer gate 36. The logic circuit section 32 is provided in an output section of the sequential circuit cell 40 and includes a buffer 37.

In the sequential circuit, the buffer section arranged in the output section is larger in delay influence than the latch section within the sequential circuit section, and accordingly, only the layout of the buffer 37 composing the logic circuit section 32 is limited.

In the semiconductor integrated circuit design method of the present embodiment, the layout is limited so that the logic circuit cell and the logic circuit section of the sequential circuit cell are composed of combinations selected from the 23 basic pattern combinations. Accordingly, extraction of the SPICE parameter in the step S24 enables formation of data of all standard cells in the step S25, resulting in a highly accurate delay library reflecting the real characteristics.

In an actual LSI, the gate length of a gate adjacent to a subject gate may vary depending on a type of cell arranged adjacent to a cell having the subject gate. In this case, preferably, a plurality of libraries are formed individually for combinations with adjacent cells and a combination is selected appropriately according to chip layout.

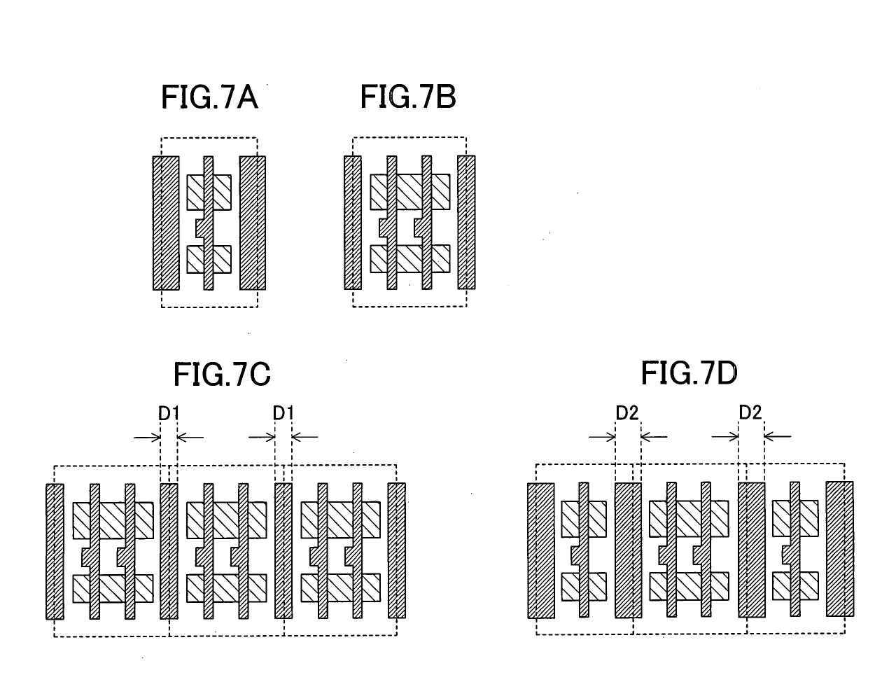

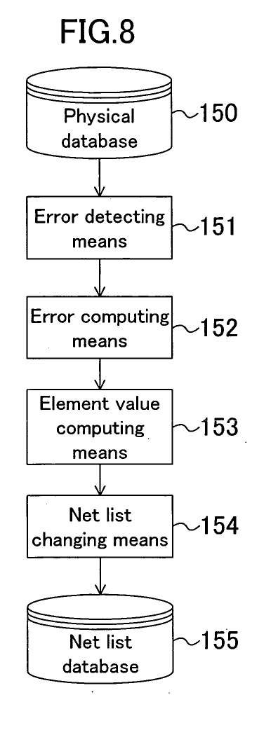

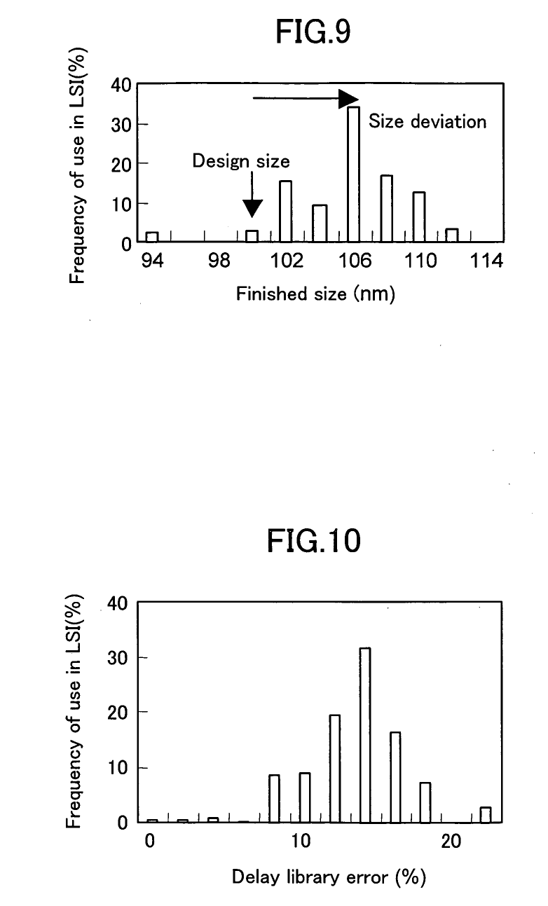

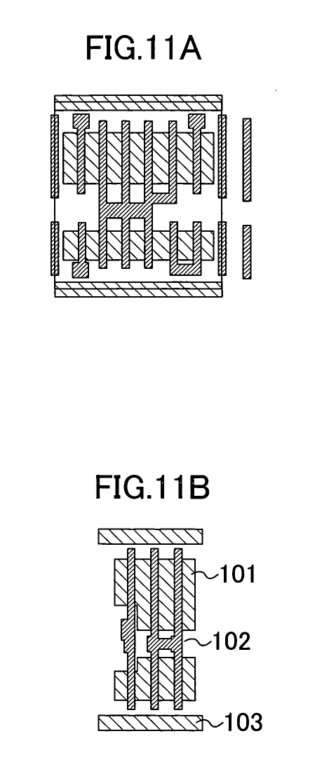

FIG. 7A to FIG. 7D show examples for library design according to combinations with adjacent cells in the semiconductor integrated circuit design method of the present embodiment. FIG. 7A to FIG. 7D show an inverter, two NANDs, two NANDs on the respective sides of which two NANDs are arranged, and two NANDs on the respective sides of which inverters are arranged, respectively.

Referring to FIG. 7C, the two NANDs on the respective sides of which the two NANDs are arranged are different from the two NANDs on the respective sides of which the inverters are arranged in pattern of the adjacent cells as viewed from the subject gate. For example, the gate length D1 of the dummy gates provided on the cell boundaries of the two NANDs on the respective sides of which the two NANDs are arranged is different from the gate length D2 of the dummy gates provided on the cell boundaries of the two NANDs on the respective sides of which the inverters are arranged.

This difference in pattern between the adjacent cells in FIG. 7C and FIG. 7D makes difference in characteristic, and accordingly, a library is formed for each combination. There are some cases where the gate length of the dummy gate is changed when the wiring pitch does not agree with the gate pitch. In these cases, several dummy gates having different gate lengths are prepared as basic patterns so that a dummy gate having a gate length appropriate to a cell is arranged, increasing accuracy in finished size of the gate length to increase delay accuracy.

It is noted that the semiconductor integrated circuit according to the present invention can be utilized in LSIs having a MIS transistor which are built in various kinds of electronic appliances.

What is claimed is:

1. A method for designing a semiconductor integrated circuit with the use of a standard cell having a plurality of gates and active regions, comprising:
a step (a) of setting basic patterns including a plurality of active region/gate patterns each including a gate and an active region and at least one dummy gate, while taking account of patterns of adjacent gates on respective sides of each gate of the plurality of gates;
a step (b) of forming a plurality of basic pattern combinations in which patterns of gates on the respective sides of each gate of the plurality of gates are different from each other by combining some of the basic patterns set in the step (a);
a step (c) of forming the standard cell by combining some of the plurality of basic pattern combinations; and
a step (d) of designing the semiconductor integrated circuit with the use of the standard cell.

2. The method of claim 1,
wherein in the step (a), the basic patterns are set taking account of only patterns of adjacent gates on the respective sides of each gate of the plurality of gates.

3. The method of claim 1,
wherein the plurality of active region/gate patterns include at least:
a first active region/gate pattern including a gate in a straight shape having a protruding pad portion serving as a contact region; and
a second active region/gate pattern including N gates in a same straight shape in parallel with each other and a bridging gate for connecting the N gates in parallel with each other, where N is a natural number larger than 1.

4. The method of claim 3,
wherein the plurality of active region/gate patterns further include a third active region/gate pattern including a gate which is in the same shape as the gate of the first active region/gate pattern and which has an active region different in width from that of the first active region/gate pattern.

5. The method of claim 1,
wherein the semiconductor integrated circuit includes a logic circuit and a sequential circuit including a sequential circuit section and a logic circuit section which receives an output from the sequential circuit section, and
the step (d) includes:
a step (d1) of extracting from the semiconductor integrated circuit a part including the logic circuit where more importance is placed on formation as designed than on area reduction;
a step (d2) of extracting the logic circuit section from the semiconductor integrated circuit; and
a step (d3) of designing the logic circuit and the logic circuit section with the use of the standard cell.

6. The method of claim 1,
wherein the semiconductor integrated circuit includes a logic circuit used for a clock line, and
the step (d) includes:
a step (d4) of extracting the logic circuit from the semiconductor integrated circuit; and
a step (d5) of designing the logic circuit with the use of the standard cell.

7. The method of claim 1,
wherein when a pitch of the plurality of gates is different from a wiring pitch in the standard cell, the basic patterns include another dummy gate different in gate length from the dummy gate.

8. A method for designing a library for a semiconductor integrated circuit designed with the used of a cell including a plurality of transistors having gates, comprising:
a step (a) of extracting a parameter in each of the plurality of transistors pattern by pattern of gates on respective sides of each of the gates; and
a step (b) of forming a library which reflects a real characteristic with the use of the parameter extracted in the step (a).
